(19) United States
(12) Patent Application Publication
(10) Pub. No.: US 2026/0358512 A1
(43) Pub. Date: Nov. 12, 2026

(54) POSITIONING INSTRUMENT, POSITIONING METHOD, AND NON-TRANSITORY COMPUTER-READABLE STORAGE MEDIUM STORING POSITIONING PROGRAM

(71) Applicant: SEIKO EPSON CORPORATION, Tokyo (JP)

(72) Inventor: Yoshiyuki MURAGUCHI, SHIOJIRI-SHI (JP)

(73) Assignee: SEIKO EPSON CORPORATION, Tokyo (JP)

(21) Appl. No.: 19/672,695

(22) Filed: May 10, 2026

(30) Foreign Application Priority Data
May 12, 2025 (JP) 2025-079367

(51) Int. Cl. G01S 19/46; G01S 19/39; G01S 19/41

(52) U.S. Cl. CPC G01S 19/46; G01S 19/396; G01S 19/41

(57) ABSTRACT

A positioning instrument includes: a receiver configured to receive a first frequency band signal and a second frequency band signal which are transmitted from a first satellite belonging to a positioning satellite system, and receive a signal in an L6 band transmitted from a second satellite belonging to a quasi-zenith satellite system; a calculation unit configured to calculate a first observation pseudo distance based on the first frequency band signal, and calculate a second observation pseudo distance based on the second frequency band signal; and a positioning unit configured to perform positioning processing, wherein the calculation unit calculates an observation error based on reinforcement information based on the signal in the L6 band and a difference between the first observation pseudo distance and the second observation pseudo distance, and the positioning unit weights a signal transmitted from the first satellite in the positioning processing in accordance with the observation error.

The present application is based on, and claims priority from JP Application Serial Number 2025-079367, filed May 12, 2025, the disclosure of which is hereby incorporated by reference herein in its entirety.

### BACKGROUND

### 1. Technical Field

The present disclosure relates to a positioning instrument, a positioning method, and a non-transitory computer-readable storage medium storing a positioning program.

### 2. Related Art

JP-A-2017-187360 describes a positioning apparatus that performs two-frequency positioning using observation data generated using GNSS signals in an L1 band and an L2 band acquired from a first antenna and CLAS reinforcement data generated using a GNSS signal in an L6 band acquired from a second antenna, performs one-frequency positioning using the GNSS signal in the L1 band acquired from the second antenna, uses a positioning result of the two-frequency positioning as a final positioning result when a difference between the positioning result of the two-frequency positioning and the positioning result of the one-frequency positioning is within a range of a preset threshold value, and uses the positioning result of the one-frequency positioning as the final positioning result when that difference exceeds the preset threshold value.

JP-A-2017-187360 is an example of the related art.

In the positioning apparatus described in JP-A-2017-187360, since a signal in the L1 band is used in both the one-frequency positioning and the two-frequency positioning, when the signal in the L1 band is affected by multipath, spoofing, or the like, there is a concern that the positioning accuracy may decrease, and it is difficult to perform positioning with high accuracy.

### SUMMARY

An aspect of a positioning instrument according to the present disclosure includes:
a receiver configured to receive a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receive a signal in an L6 band transmitted from a second satellite belonging to the quasi-zenith satellite system;
a calculation unit configured to calculate a first observation pseudo distance as an observation value of a pseudo distance to the first satellite based on the first frequency band signal, and calculate a second observation pseudo distance as an observation value of a pseudo distance to the first satellite based on the second frequency band signal; and
a positioning unit configured to perform positioning processing, wherein
the calculation unit calculates an observation error that is a difference between an error contained in the first observation pseudo distance and an error contained in the second observation pseudo distance based on reinforcement information of a centimeter-class positioning reinforcement service (CLAS) contained in the signal in the L6 band and a difference between the first observation pseudo distance and the second observation pseudo distance, and
the positioning unit weights a signal transmitted from the first satellite in the positioning processing in accordance with the observation error.

An aspect of a positioning method according to the present disclosure includes:
a reception step of receiving a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receiving a signal in an L6 band transmitted from a second satellite belonging to the quasi-zenith satellite system;
a calculation step of calculating a first observation pseudo distance as an observation value of a pseudo distance to the first satellite based on the first frequency band signal, and calculating a second observation pseudo distance as an observation value of a pseudo distance to the first satellite based on the second frequency band signal; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in the signal in the L6 band and a difference between the first observation pseudo distance and the second observation pseudo distance, and
in the positioning step, weighting of a signal transmitted from the first satellite in the positioning processing is performed in accordance with the observation error.

An aspect of a non-transitory computer-readable storage medium storing a positioning program according to the present disclosure causes a computer to execute processing including:
a calculation step of calculating a first observation pseudo distance as an observation value of a pseudo distance to a first satellite belonging to a quasi-zenith satellite system or a positioning satellite system different from the quasi-zenith satellite system based on a first frequency band signal as a signal in a first frequency band transmitted from the first satellite, and calculating a second observation pseudo distance as an observation value of a pseudo distance to the first satellite based on a second frequency band signal as a signal in a second frequency band which is transmitted from the first satellite; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in a signal in an L6 band transmitted from a second satellite belonging to the quasi-zenith satellite system and a difference between the first observation pseudo distance and the second observation pseudo distance, and
in the positioning step, weighting of a signal transmitted from the second satellite in the positioning processing is performed in accordance with the observation error.

### BRIEF DESCRIPTION OF THE DRAWINGS

FIG. 1 is a diagram illustrating an outline of a positioning instrument of the present embodiment.

FIG. 2 is a diagram showing a configuration example of the positioning instrument of the present embodiment.

FIG. 3 is a diagram showing a configuration of a navigation message in an L1 band in GPS.

FIG. 4 is a diagram showing a configuration of a navigation message in an L5 band in GPS.

FIG. 5 is a diagram illustrating spoofing.

FIG. 6 is a flowchart showing an example of a procedure of a positioning method of the present embodiment.

FIG. 7 is a flowchart showing an example of a procedure of a reception step, a calculation step, and a positioning step in a first embodiment.

FIG. 8 is a flowchart showing an example of the procedure of the positioning step in a second embodiment.

FIG. 9 is a flowchart showing an example of the procedure of the calculation step in a third embodiment.

### DESCRIPTION OF EMBODIMENTS

Some preferred embodiments of the present disclosure will hereinafter be described in detail with reference to the drawings. Note that the embodiments described below do not unreasonably limit the content of the present disclosure set forth in the appended claims. Further, all the configurations described below are not necessarily essential elements of the present disclosure.

### 1. First Embodiment

### 1-1. Outline of Positioning Instrument

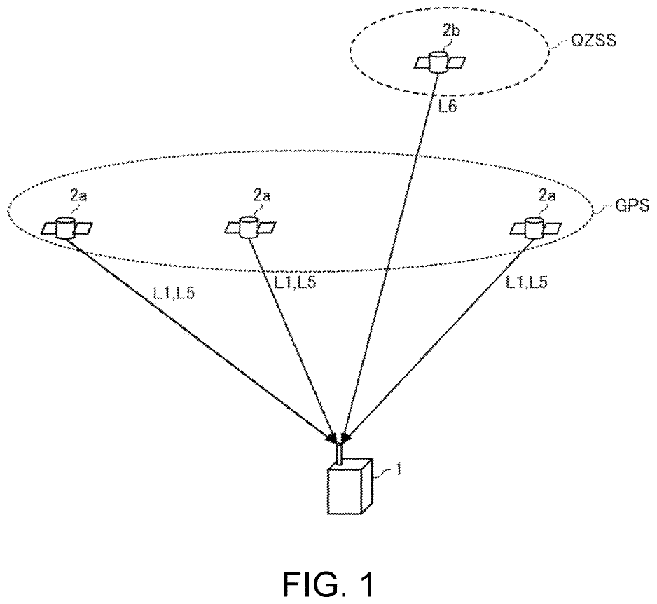

FIG. 1 is a diagram illustrating an outline of a positioning instrument 1 of the present embodiment. As illustrated in FIG. 1, the positioning instrument 1 receives signals transmitted respectively from a plurality of satellites 2a and performs positioning processing based on the signals thus received. Each of the satellites 2a is an artificial satellite orbiting a predetermined orbit above the earth and constitutes a part of GNSS. GNSS is an abbreviation for Global Navigation Satellite System. Examples of the GNSS include GPS, QZSS, EGNOS, GLONASS, GALILEO, and BeiDou. GPS is an abbreviation for Global Positioning System. QZSS is an abbreviation for Quasi-Zenith Satellite System. EGNOS is an abbreviation for European Geostationary Navigation Overlay Service. GLONASS is an abbreviation for Global Navigation Satellite System.

The positioning instrument 1 receives an L6D signal that is a satellite signal in an L6 band transmitted from at least one of a plurality of satellites 2b belonging to the quasi-zenith satellite system (QZSS). Each of the satellites 2b is an artificial satellite orbiting a quasi-zenith orbit. The L6 band is a frequency band having a center frequency of 1.27875 GHz, and the L6D signal includes reinforcement information of centimeter-class positioning reinforcement service (CLAS). The reinforcement information is information for improving positioning accuracy, and includes information of a satellite position error, information of a satellite time error, information of signal bias, information of an ionospheric delay amount estimation error, and information of a tropospheric delay amount estimation error with respect to each of the satellites 2a.

A positioning satellite system to which each of the satellites 2a belongs may be the quasi-zenith satellite system (QZSS) or may be a positioning satellite system different from the quasi-zenith satellite system (QZSS). In the former case, at least one of the plurality of satellites 2a corresponds to the satellite 2b. Hereinafter, description will be presented citing when the satellite system to which each of the satellites 2a belongs is the GPS as illustrated in FIG. 1 as an example.

Each of the satellites 2a of the GPS transmits, to the ground, a satellite signal formed by superimposing a navigation message on radio waves in a plurality of frequency bands such as an L1 band having a center frequency of 1.57542 GHz and an L2 band having a center frequency of 1.22760 GHz. In the GPS, approximately thirty satellites 2a are present. In order to identify the satellite 2a that has transmitted the satellite signal, the satellite signal in the L1 band includes an identification code formed of a unique pattern in 1023 chips. The identification code in the L1 band is called a C/A code. Each of the chips is either +1 or −1. The identification code appears like a random pattern, and is repeated at a cycle of 1 msec. C/A code is an abbreviation for Coarse/Acquisition Code. As described above, a chip rate of the satellite signal in the L1 band is 1.023 Mcps (=1023 chips/msec).

Some of the satellites 2a constituting the GPS also transmit, to the ground, a satellite signal obtained by superimposing a navigation message on a radio wave in an L5 band having a center frequency of 1.17645 GHz. The satellite signal in the L5 band includes an identification code formed of a unique pattern in 10230 chips. Similarly to the C/A code, each of the chips of that identification code is either +1 or −1, that identification code appears like a random pattern, and is repeated at a cycle of 1 msec. As described above, the chip rate of the satellite signal in the L5 band is 10.23 Mcps (=10230 chips/msec), which is ten times the chip rate of the satellite signal in the L1 band.

The positioning instrument 1 receives a first frequency band signal as a signal in a first frequency band and a second frequency band signal as a signal in a second frequency band transmitted from each of the satellites 2a. Then, the positioning instrument 1 weights the signal transmitted from each of the satellites 2a with respect to the positioning processing based on reinforcement information contained in the L6D signal received from the satellite 2b, and the first frequency band signal and the second frequency band signal received from each of the satellites 2a. Hereinafter, the description will be presented assuming that the first frequency band is the L1 band and the second frequency band is the L5 band. That is, the description will be presented assuming that the positioning instrument 1 receives an L1 signal, which is a signal in the L1 band, as the first frequency band signal, and receives an L5 signal, which is a signal in the L5 band, as the second frequency band signal. However, a combination of the first frequency band and the second frequency band is not limited to the combination of the L1 band and the L5 band of the GPS, and may be, for example, a combination of the L1 band and the L2 band of the GPS or a combination of the L2 band and the L5 band of the GPS. For example, the combination of the first frequency band and the second frequency band may be a combination of an L1 band and an L5 band of the QZSS or a combination of an E1 band and an E5a band of the Galileo.

### 1-2. Configuration of Positioning Instrument

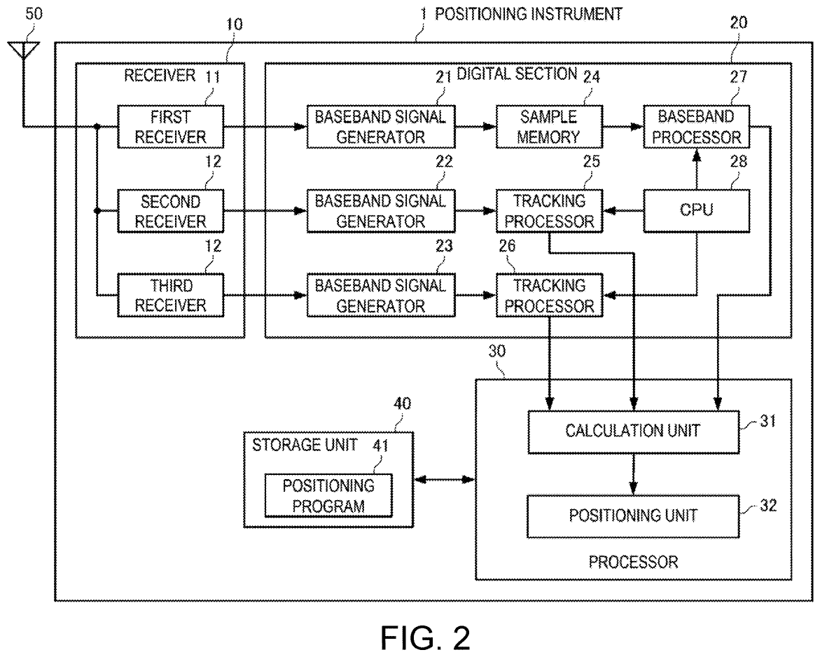

FIG. 2 is a diagram showing a configuration example of the positioning instrument 1 of the present embodiment. As illustrated in FIG. 2, the positioning instrument 1 of the present embodiment includes an antenna 50, a receiver 10, a digital section 20, a processor 30, and a storage unit 40. The positioning instrument 1 may have a configuration in which some of the elements in FIG. 2 are omitted or changed, or another element is added.

The antenna 50 is an antenna that receives a signal transmitted from each of the satellites 2a, 2b.

The receiver 10 receives the L1 signal and the L5 signal transmitted from each of the satellites 2a, and receives the L6D signal transmitted from each of the satellites 2b. As shown in FIG. 2, the receiver 10 includes a first receiver 11, a second receiver 12, and a third receiver 13. The first receiver 11, the second receiver 12, and the third receiver 13 are coupled to the antenna 50. The first receiver 11 receives the L1 signal transmitted from each of the satellites 2a via the antenna 50. The second receiver 12 receives the L5 signal transmitted from each of the satellites 2a via the antenna 50. The third receiver 13 receives the L6D signal transmitted from each of the satellites 2b via the antenna 50.

In the present embodiment, the first receiver 11 converts the L1 signal thus received into an intermediate frequency signal, and then outputs the intermediate frequency signal. Specifically, the first receiver 11 extracts the L1 signal from the signals received by the antenna 50 with a bandpass filter, and amplifies the L1 signal thus extracted with LNA, mixes the signal thus amplified and a clock signal with a predetermined frequency with a mixer, and then down-converts the signal thus mixed into a signal in an intermediate frequency band of, for example, several MHz. LNA is an abbreviation for Low Noise Amplifier. Then, the first receiver 11 performs amplification and low-pass filter processing on the signal in the intermediate frequency band, then converts the result into a digital signal with an AD converter, and outputs the digital signal.

Similarly, the second receiver 12 converts the L5 signal thus received into an intermediate frequency signal and then outputs the intermediate frequency signal. Specifically, the second receiver 12 extracts the L5 signal from the signals received by the antenna 50 with a bandpass filter, and amplifies the L5 signal thus extracted with LNA, mixes the signal thus amplified and a clock signal with a predetermined frequency with a mixer, and then down-converts the signal thus mixed into a signal in an intermediate frequency band of, for example, several MHz. Then, the second receiver 12 performs amplification and low-pass filter processing on the signal in the intermediate frequency band, then converts the result into a digital signal with an AD converter, and outputs the digital signal.

Similarly, the third receiver 13 converts the L6D signal thus received into an intermediate frequency signal and then outputs the intermediate frequency signal. Specifically, the third receiver 13 extracts the L6D signal from the signals received by the antenna 50 with a bandpass filter, and amplifies the L6D signal thus extracted with LNA, mixes the signal thus amplified and a clock signal with a predetermined frequency with a mixer, and then down-converts the signal thus mixed into a signal in an intermediate frequency band of, for example, several MHz. Then, the third receiver 13 performs amplification and low-pass filter processing on the signal in the intermediate frequency band, then converts the result into a digital signal with an AD converter, and outputs the digital signal.

As illustrated in FIG. 2, the digital section 20 includes baseband signal generators 21, 22, and 23, a sample memory 24, tracking processors 25, 26, a baseband processor 27, and a CPU 28. DDC is an abbreviation for Digital Down Converter. CPU is an abbreviation for Central Processing Unit.

The baseband signal generator 21 converts the intermediate frequency signal output from the first receiver 11 into a digital signal having a center frequency of 0 Hz. Specifically, the baseband signal generator 21 generates, for example, a digital signal as a sine-wave at several megahertz, mixes the intermediate frequency signal with the digital signal as the sine-wave, then performs low-pass filter processing on the result, converts the result into a digital signal having a center frequency of 0 Hz, and then outputs the digital signal. Further, the baseband signal generator 21 down-samples the digital signal and then outputs a baseband signal.

Similarly, the baseband signal generator 22 converts the intermediate frequency signal output from the second receiver 12 into a digital signal having a center frequency of 0 Hz. Specifically, the baseband signal generator 22 generates, for example, a digital signal as a sine-wave at several megahertz, mixes the intermediate frequency signal with the digital signal as the sine-wave, then performs low-pass filter processing on the result, converts the result into a digital signal having a center frequency of 0 Hz, and then outputs the digital signal. Further, the baseband signal generator 22 down-samples the digital signal and then outputs a baseband signal.

Similarly, the baseband signal generator 23 converts the intermediate frequency signal output from the third receiver 13 into a digital signal having a center frequency of 0 Hz. Specifically, the baseband signal generator 23 generates, for example, a digital signal as a sine-wave at several megahertz, mixes the intermediate frequency signal with the digital signal as the sine-wave, then performs low-pass filter processing on the result, converts the result into a digital signal having a center frequency of 0 Hz, and then outputs the digital signal. Further, the baseband signal generator 23 down-samples the digital signal and then outputs a baseband signal.

The sample memory 24 sequentially stores the baseband signals output from the baseband signal generator 21. In the present embodiment, the sample memory 24 stores the baseband signals for a time period equal to or longer than one cycle of the C/A code contained in the L1 signal received by the first receiver 11, that is, for a time period equal to or longer than 1 msec.

The baseband processor 27 processes the baseband signal stored in the sample memory 24. Specifically, the baseband processor 27 generates a local code having the same pattern as that of each C/A code, and performs a satellite search as processing of obtaining a correlation between each C/A code contained in the baseband signal and the local code. Specifically, the baseband processor 27 adjusts the phase and the chip rate of the local code so that a correlation value with respect to each local code makes a peak, and determines that the satellite 2a having the local code as the C/A code is synchronized, that is, the satellite 2a is captured when the correlation value is equal to or larger than a threshold value.

Note that the GPS adopts a CDMA method in which all the satellites 2a transmit satellite signals at the same frequency using the C/A codes different from each other. Therefore, the baseband processor 27 can search for the satellite 2a that can be captured by determining the C/A code contained in the satellite signal received. CDMA is an abbreviation for Code Division Multiple Access.

When the satellite 2a is captured based on the baseband signal, the baseband processor 27 calculates a frequency offset of the satellite signal based on that chip rate, calculates the code phase based on the phase of the local code, and generates satellite capture information containing the frequency offset and the code phase of the satellite signal. The baseband processor 27 mixes the local code having the same pattern as the C/A code of each captured satellite 2a and the baseband signal at an appropriate timing based on the frequency offset and the code phase of the satellite signal contained in each satellite capture information, and demodulates a navigation message in the L1 band of each of the satellites 2a.

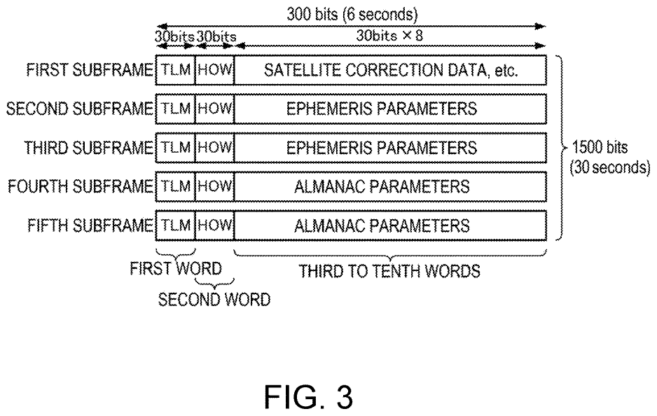

FIG. 3 shows a configuration of the navigation message in the L1 band. As illustrated in FIG. 3, the navigation message in the L1 band is configured as data with a main frame having a total number of bits of 1,500 as one unit. The main frame is divided into first to fifth subframes as five subframes each having 300 bits from the head. The data of one subframe is transmitted in six seconds from each of the satellites 2a. Therefore, the data of one main frame is transmitted in thirty seconds from each of the satellites 2a.

The 300-bit data respectively contained in the five subframes is divided into first to tenth words with 30 bits as one word from the head. In each subframe, the first word is a TLM word and the second word is a HOW word. TLM is an abbreviation for TeLeMetry, and HOW is an abbreviation for Hand Over Word. Therefore, the TLM word and the HOW word are transmitted from the satellite 2a at intervals of six seconds.

The TLM word includes preamble data, a TLM message, reserved bits, and parity data.

The HOW word includes time information called TOW or Z count. TOW is an abbreviation for Time Of Week. Z count data is set such that an elapsed time from 0 o'clock on Sunday every week is expressed in seconds and is reset to zero at 0 o'clock on Sunday next week. That is, the Z count data is information in units of seconds indicated every week from the beginning of the week and the elapsed time is a number expressed in units of 1.5 seconds. Here, the Z count data indicates information concerning time when the leading bit of the next subframe data is transmitted. For example, the Z count data of the first subframe indicates information concerning time when the leading bit of the second subframe is transmitted. The HOW word also includes a 3-bit ID code indicating the ID of the subframe. More specifically, the HOW words of the first to fifth subframes include ID codes “001”, “010”, “011”, “100”, and “101”, respectively. The time of the satellite 2a can be calculated from week number data contained in the first subframe and the HOW word contained in each subframe.

The third to tenth words of the first subframe include satellite correction data such as a week number, a state of the satellite 2a, and clock correction coefficients. Specifically, the third word includes the week number and the state of the satellite 2a and the eighth to tenth words include the clock correction coefficients. The third to tenth words of each of the second and third subframes include ephemeris parameters, which are detailed orbit information of the satellite 2a. The third to tenth words of each of the fourth and fifth subframes include almanac parameters, which are approximate orbit information of all the satellites 2a. Therefore, the satellite correction data, the ephemeris parameters, and the almanac parameters are transmitted from the satellite 2a at intervals of thirty seconds.

Going back to the description of FIG. 2, the tracking processor 25 processes the baseband signal output from the baseband signal generator 22. Specifically, the tracking processor 25 generates a local code having the same pattern as that of each identification code, and performs a satellite search that is processing of obtaining a correlation between each identification code contained in the baseband signal and the local code. That is, the tracking processor 25 adjusts the phase and the chip rate of the local code to set the correlation value for each local code to be a peak, and determines that the satellite 2a having the local code as the identification code is synchronized, that is, the satellite 2a is captured when the correlation value is equal to or larger than a threshold value.

When the satellite 2a is captured based on the baseband signal, the tracking processor 25 calculates the frequency offset of the satellite signal based on the chip rate, calculates the code phase based on the phase of the local code, and generates the satellite capture information containing the frequency offset and the code phase of the satellite signal. The tracking processor 25 mixes the local code having the same pattern as the identification code of each captured satellite 2a and the baseband signal at an appropriate timing based on the frequency offset and the code phase of the satellite signal contained in each satellite capture information, and demodulates a navigation message in the L5 band of each of the satellites 2a.

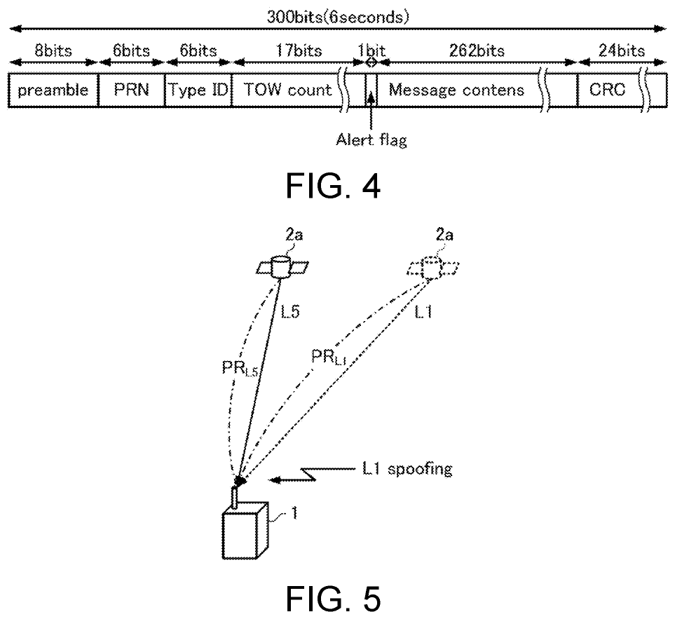

FIG. 4 shows a configuration of the navigation message in the L5 band. As illustrated in FIG. 4, the navigation message in the L5 band is configured as data having a 300-bit message as one unit and is transmitted in six seconds. The 300-bit data configuring each message includes an 8-bit preamble, a 6-bit satellite number PRN, a 6-bit message type ID, a 17-bit message TOW count, a 1-bit alert flag, a 262-bit message content, and a 24-bit CRC from the head. CRC is an abbreviation for Cyclic Redundancy Check.

The message TOW count is a TOW count simplified into 17 bits and is expressed in units of six seconds. An actual TOW count is set such that an elapsed time from 0 o'clock on Sunday every week is expressed in seconds and is reset to zero at 0 o'clock on Sunday next week. That is, the actual TOW count is information in units of seconds indicated every week from the beginning of the week and the elapsed time is a number expressed in units of 1.5 seconds. The actual TOW count simplified and expressed in 17 bits is the message TOW count.

The message content is different depending on the message type ID but includes information that is the same as or similar to the information contained in the navigation message in the L1 band.

Going back to the description of FIG. 2, the tracking processor 26 processes the baseband signal output from the baseband signal generator 23. Specifically, the tracking processor 26 generates a local code having the same pattern as that of each identification code, and performs a satellite search that is processing of obtaining a correlation between each identification code contained in the baseband signal and the local code. That is, the tracking processor 26 adjusts the phase and the chip rate of the local code to set the correlation value for each local code to be a peak, and determines that the satellite 2b having the local code as the identification code is synchronized, that is, the satellite 2b is captured when the correlation value is equal to or larger than a threshold value.

When the satellite 2b is captured based on the baseband signal, the tracking processor 26 calculates the frequency offset of the satellite signal based on the chip rate, calculates the code phase based on the phase of the local code, and generates the satellite capture information containing the frequency offset and the code phase of the satellite signal. The tracking processor 26 mixes the local code having the same pattern as the identification code of each captured satellite 2b and the baseband signal at an appropriate timing based on the frequency offset and the code phase of the satellite signal contained in each satellite capture information, and demodulates a CLAS message of each of the satellites 2b. The CLAS message includes the reinforcement information described above.

The CPU 28 controls operations of the baseband processor 27 and the tracking processors 25, 26.

As illustrated in FIG. 2, the processor 30 includes a calculation unit 31 and a positioning unit 32.

The calculation unit 31 calculates an observation pseudo distance PR_{L1} which is an observation value of a pseudo distance to the satellite 2a based on the L1 signal of the GPS, and calculates an observation pseudo distance PR_{L5} which is an observation value of the pseudo distance to the satellite 2a based on the L5 signal of the GPS. Specifically, the calculation unit 31 calculates a difference between the time at the satellite 2a and the time at the reception point based on the satellite capture information in the L1 band of the satellite 2a generated by the baseband processor 27 and the navigation message, and calculates the observation pseudo distance PR_{L1} by multiplying that difference between the times by the speed of light. Similarly, the calculation unit 31 calculates the difference between the time at the satellite 2a and the time at the reception point based on the satellite capture information in the L5 band of the satellite 2a generated by the tracking processor 25 and the navigation message, and calculates the observation pseudo distance PR_{L5} by multiplying the difference between the times by the speed of light.

Further, the calculation unit 31 calculates an observation error (Error_{L5}−Error_{L1}), which is a difference between an error Error_{L1} contained in the observation pseudo distance PR_{L1} and an error Error_{L5} contained in the observation pseudo distance PR_{L5}, based on the reinforcement information of the centimeter-class positioning reinforcement service (CLAS) contained in the L6D signal transmitted from the satellite 2b of QZSS and a difference (PR_{L5}−PR_{L1}) between the observation pseudo distance PR_{L1} and the observation pseudo distance PR_{L5}. As described above, the reinforcement information of the CLAS includes information of an ionospheric delay amount estimation error, and the calculation unit 31 calculates a difference (γ₁₅·Iono_{L1}−Iono_{L1}) between a distance Iono_{L1} corresponding to a delay of the L1 signal due to the influence of the ionospheric layer and a distance γ₁₅·Iono_{L1} corresponding to a delay of the L5 signal due to the influence of the ionospheric layer based on that reinforcement information. Then, the calculation unit 31 calculates the observation error (Error_{L5}−Error_{L1}) by a formula (3) described later based on the difference (PR_{L5}−PR_{L1}) and the difference (γ₁₅·Iono_{L1}−Iono_{L1}).

Specifically, the observation equation of the L1 signal is expressed by a formula (1), and the observation equation of the L5 signal is expressed by a formula (2).

PR_{L1}=ρ+Bias+Trop−c·(−T_{GD}+ISC_{L1})+Error_{L1}+Iono_{L1} (1)

PR_{L5}=ρ+Bias+Trop−c·(−T_{GD}+ISC_{L5})+Error_{L5}+γ₁₅·Iono_{L1}+IFB (2)

In the formulas (1) and (2), p is a geometric distance between the satellite 2a and the positioning instrument 1. Further, Bias is obtained by converting a time error between the GPS and the positioning instrument 1 into a distance, and Trop is obtained by converting a delay due to the influence of the troposphere into a distance. In addition, c is the speed of light, and T_{GD} is a group delay. Further, ISC_{L1} is a delay amount of the L1 signal unique to the satellite 2a contained in the navigation message in the L5 band, and ISC_{L5} is a delay amount of the L5 signal unique to the satellite 2a contained in the navigation message in the L5 band. Further, Error_{L1} is an error of the distance contained in the L1 signal, and Error_{L5} is an error of the distance contained in the L5 signal. Further, Iono_{L1} is obtained by converting the delay of the L1 signal due to the influence of the ionospheric layer into a distance, and γ₁₅·Iono_{L1} is obtained by converting the delay of the L5 signal due to the influence of the ionospheric layer into a distance. The reference symbol γ₁₅ represents ((center frequency of L1 band)/(center frequency of L5 band))². IFB is an abbreviation for Internal Frequency Bias, and is obtained by converting a time difference between processing of the L1 signal and processing of the L5 signal in the positioning instrument 1 into a distance. Here, the IFB is obtained by converting a delay of the processing of the L5 signal with respect to the processing of the L1 signal in the positioning instrument 1 into a distance.

The formula (3) is obtained by taking a difference between the formula (1) and the formula (2).

(Error_{L5}−Error_{L1})=(PR_{L5}−PR_{L1})−(−c·(ISC_{L5}−ISC_{L1}))+γ₁₅·Iono_{L1}−Iono_{L1}−IFB (3)

In the formula (3), the IFB is determined by a model of the positioning instrument 1, and is a constant value calculated in advance at, for example, the time of designing the positioning instrument 1. The speed of light c is a constant value, and ISC_{L1}, ISC_{L5} are contained in the navigation message in the L5 band. The reference symbol γ₁₅ is calculated as (1.57542 GHz/1.17645 GHz)², and Iono_{L1} is calculated using some of parameters C₀₀, C₀₁, C₁₀, C₁₁, C₀₂, and C₂₀ each of which is information of the ionospheric delay amount estimation error contained in the CLAS message. Therefore, the calculation unit 31 can calculate the observation error (Error_{L5}−Error_{L1}) by the formula (3).

The positioning unit 32 performs the positioning processing for measuring the position of the positioning instrument 1 based on at least one of the L1 signal and the L5 signal received by the receiver 10 from each of the satellites 2a. Specifically, the positioning unit 32 performs the positioning processing based on at least one of the satellite capture information and the navigation message in the L1 band generated by the baseband processor 27, and the satellite capture information and the navigation message in the L5 band generated by the tracking processor 25. The positioning unit 32 may perform the positioning processing based on a signal different from the L1 signal and the L5 signal, such as the L2 signal. Various known methods can be applied as the positioning processing, and a person skilled in the art can easily perform the positioning processing, and thus the description thereof will be omitted.

The positioning unit 32 weights the signal transmitted from each of the satellites 2a in the positioning processing in accordance with the observation error (Error_{L5}−Error_{L1}) which is the calculation result by the calculation unit 31. For example, the positioning unit 32 may perform positioning processing using the L1 signal by weighting the L1 signal transmitted from each of the satellites 2a in accordance with the observation error (Error_{L5}−Error_{L1}). In addition, for example, the positioning unit 32 may weight the L5 signal transmitted from each of the satellites 2a in accordance with the observation error (Error_{L5}−Error_{L1}) and perform the positioning processing using the L5 signal. Further, for example, the positioning unit 32 may weight the L1 signal and the L5 signal transmitted from each of the satellites 2a in accordance with the observation error (Error_{L5}−Error_{L1}) to perform the positioning processing using the L1 signal and the L5 signal. The positioning unit 32 may weight a signal different from the L1 signal and the L5 signal transmitted from each of the satellites 2a, such as the L2 signal to perform the positioning processing using that signal.

In the present embodiment, when the observation error (Error_{L5}−Error_{L1}) with respect to the satellite 2a is equal to or larger than a first threshold value, the positioning unit 32 performs the positioning processing without using the signal transmitted from that satellite 2a. That is, the positioning unit 32 zeros the weighting of the signal transmitted from the satellite 2a the observation error (Error_{L5}−Error_{L1}) to which is equal to or larger than the first threshold value, and performs the positioning processing without using the signal transmitted from that satellite 2a. When the observation error (Error_{L5}−Error_{L1}) with respect to the satellite 2a is smaller than the first threshold value, the positioning unit 32 may perform the positioning processing without using the signal transmitted from that satellite 2a.

Note that the first threshold value is a positive value, and “when the observation error (Error_{L5}−Error_{L1}) is equal to or larger than the first threshold value” accurately means “when an absolute value of the observation error (Error_{L5}−Error_{L1}) is equal to or larger than the first threshold value”. Similarly, “when the observation error (Error_{L5}−Error_{L1}) is smaller than the first threshold value” accurately means “when the absolute value of the observation error (Error_{L5}−Error_{L1}) is smaller than the first threshold value”.

As shown in FIG. 5, when the L1 signal transmitted from the satellite 2a is spoofed and the L5 signal transmitted from the satellite 2a is not spoofed, a difference between the observation pseudo distance PR_{L5} based on the L5 signal and the observation pseudo distance PR_{L1} based on the L1 signal becomes large. That is, the observation error (Error_{L5}−Error_{L1}) increases. Therefore, for example, the first threshold value is set to a value with which whether there is a high possibility that the L1 signal or the L5 signal is spoofed can be determined. In this case, when the observation error (Error_{L5}−Error_{L1}) with respect to the satellite 2a is equal to or larger than the first threshold value, since there is a high possibility that at least a part of the signal transmitted from that satellite 2a is spoofed, the positioning unit 32 can perform the positioning processing without using the signal transmitted from that satellite 2a.

For example, the first threshold value may be a value based on the sum of the distance corresponding to one chip of the L1 signal and the distance corresponding to one chip of the L5 signal. Specifically, since the chip rate of the L1 signal is 1.023 Mcps (=1023 chips/msec), a value obtained by dividing the speed of light c [m/msec] by 1023 [chips/msec] is 293 [m/chip]. Since the chip rate of the L5 signal is 10.23 Mcps (=10230 chips/msec), a value obtained by dividing the speed of light c [m/msec] by 10230 [chips/msec] is 29.3 [m/chip]. Therefore, a maximum value of the observation error (Error_{L5}−Error_{L1}) that may occur when neither the L1 signal nor the L5 signal is spoofed is 293 m+29.3 m=322.3 m, and when the observation error (Error_{L5}−Error_{L1}) is 322.3 m or larger, there is a high possibility that the L1 signal or the L5 signal is spoofed. Therefore, for example, 330 m may be set as the first threshold value taking a margin with respect to 322.3 m.

Further, the positioning unit 32 may perform the positioning processing without using the signal transmitted from the satellite 2a when the observation error (Error_{L5}−Error_{L1}) with respect to that satellite 2a is equal to or larger than a second threshold value, and may perform the positioning processing using the signal transmitted from that satellite 2a when the observation error (Error_{L5}−Error_{L1}) is smaller than the second threshold value. The second threshold value is a value smaller than the first threshold value. For example, the observation error (Error_{L5}−Error_{L1}) increases when the delay of the L1 signal or the L5 signal increases due to an influence of multipath, but the observation error (Error_{L5}−Error_{L1}) is small compared to when the L1 signal or the L5 signal is spoofed. Therefore, it is possible to set the second threshold value in accordance with the maximum value of the observation error (Error_{L5}−Error_{L1}) that may occur due to a factor other than spoofing, such as the multipath. In this case, when the observation error (Error_{L5}−Error_{L1}) with respect to the satellite 2a is equal to or larger than the second threshold value, there is a high possibility that at least some of the signals transmitted from that satellite 2a are affected by the multipath or the like, and thus the positioning unit 32 can perform the positioning processing without using the signals transmitted from that satellite 2a.

Note that the second threshold value is a positive value, and “when the observation error (Error_{L5}−Error_{L1}) is equal to or larger than the second threshold value” accurately means “when the absolute value of the observation error (Error_{L5}−Error_{L1}) is equal to or larger than the second threshold value”. Similarly, “when the observation error (Error_{L5}−Error_{L1}) is smaller than the second threshold value” accurately means “when the absolute value of the observation error (Error_{L5}−Error_{L1}) is smaller than the second threshold value”.

The storage unit 40 stores programs, data, and so on to be used in the processing of the processor 30. The storage unit 40 is also used as a work area of the processor 30, and temporarily stores calculation results and the like of the processor 30. In the present embodiment, the processor 30 is, for example, a CPU, and functions as the calculation unit 31 and the positioning unit 32 by executing a positioning program 41 stored in the storage unit 40.

That is, in the positioning instrument 1 of the present embodiment, the receiver 10 and the digital section 20 are implemented by hardware, and the processor 30 is implemented by software. However, at least a part of the digital section 20 may be implemented by software, and at least a part of the processor 30 may be implemented by hardware.

### 1-3. Positioning Method

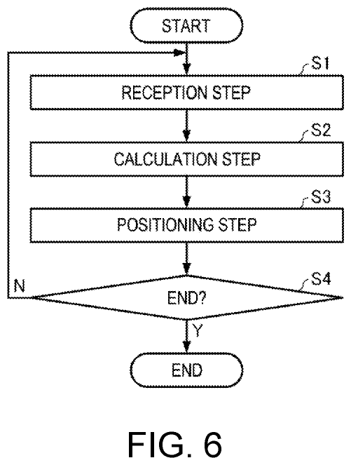

FIG. 6 is a flowchart showing an example of a procedure of a positioning method executed by the positioning instrument 1 of the present embodiment.

As illustrated in FIG. 6, first, in a reception step S1, the receiver 10 receives the L1 signal and the L5 signal transmitted from each of the satellites 2a and receives the L6D signal transmitted from each of the satellites 2b.

Then, in a calculation step S2, the calculation unit 31 calculates the observation pseudo distance PR_{L1} to each of the satellites 2a based on the L1 signal received in step S1 by the receiver 10 from each of the satellites 2a, and calculates the observation pseudo distance PR_{L5} to each of the satellites 2a based on the L5 signal received in step S1 by the receiver 10. Further, the calculation unit 31 calculates the observation error (Error_{L5}−Error_{L1}) based on the reinforcement information of the centimeter-class positioning reinforcement service (CLAS) contained in the L6D signal received in step S1 by the receiver 10 and the difference (PR_{L5}−PR_{L1}) between the observation pseudo distance PR_{L1} and the observation pseudo distance PR_{L5}.

Then, in a positioning step S3, the positioning unit 32 performs the positioning processing of measuring the position of the positioning instrument 1. The positioning unit 32 weights the signal transmitted from each of the satellites 2a in the positioning processing in accordance with the observation error (Error_{L5}−Error_{L1}) which is a calculation result by the calculation unit 31 in step S2. For example, the positioning unit 32 weights at least one of the L1 signal and the L5 signal transmitted from each of the satellites 2a in accordance with the observation error (Error_{L5}−Error_{L1}) to perform the positioning processing.

Then, the processing in steps S1 to S3 is repeated until the positioning is finished in step S4.

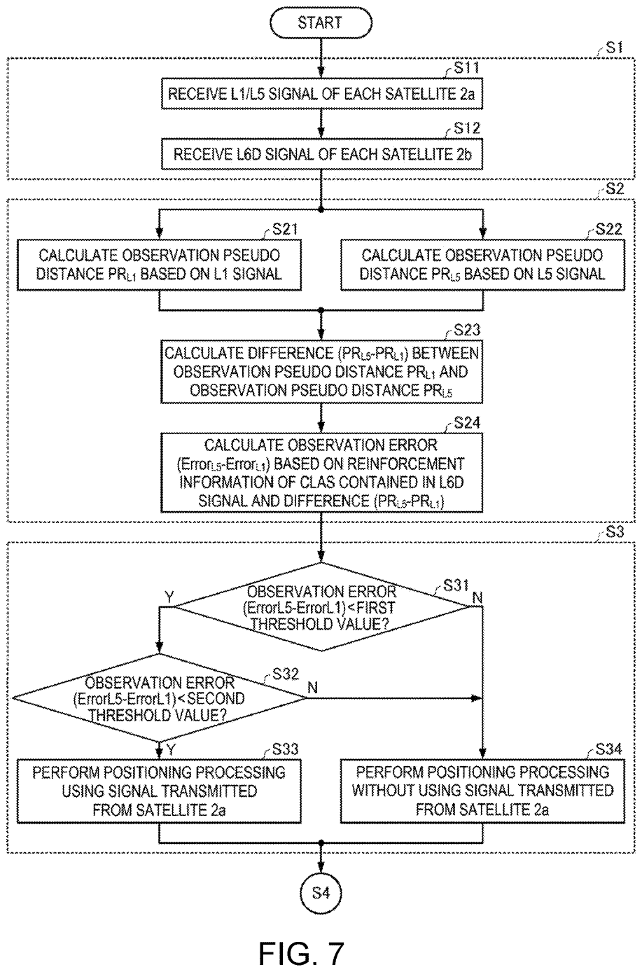

FIG. 7 is a flowchart illustrating an example of a procedure in steps S1 to S3 of the flowchart illustrated in FIG. 6.

As shown in FIG. 7, the reception step S1 includes steps S11, S12. Further, the calculation step S2 includes steps S21, S22, S23, and S24. Further, the positioning step S3 includes steps S31, S32, S33, and S34.

As illustrated in FIG. 7, first, in step S11, the receiver 10 receives the L1 signal and the L5 signal of each of the satellites 2a. In step S12, the receiver 10 receives the L6D signal of each of the satellites 2b.

Then, in step S21, the calculation unit 31 calculates the observation pseudo distance PR_{L1} to each of the satellites 2a based on the L1 signal received in step S11 by the receiver 10 from each of the satellites 2a. In step S22, the calculation unit 31 calculates the observation pseudo distance PR_{L5} to each of the satellites 2a based on the L5 signal received in step S11 by the receiver 10.

Then, in step S23, the calculation unit 31 calculates the difference (PR_{L5}−PR_{L1}) between the observation pseudo distance PR_{L1} obtained in step S21 and the observation pseudo distance PR_{L5} obtained in step S22.

Then, in step S24, the calculation unit 31 calculates the observation error (Error_{L5}−Error_{L1}) by the formula (3) described above based on the reinforcement information of the CLAS contained in the L6D signal received in step S12 by the receiver 10 from each of the satellites 2b and the difference (PR_{L5}−PR_{L1}) obtained in step S23.

Then, when the observation error (Error_{L5}-Error_{L}) obtained in step S24 is smaller than the first threshold value in step S31, and further the observation error (Error_{L5}−Error_{L1}) is smaller than the second threshold value in step S32, the positioning unit 32 performs the positioning processing in step S33 using the signal transmitted from the satellite 2a in which that observation error (Error_{L5}−Error_{L1}) is calculated. For example, the positioning unit 32 performs the positioning processing based on at least one of the L1 signal and the L5 signal received in step S11 by the receiver 10 from that satellite 2a.

On the other hand, when the observation error (Error_{L5}−Error_{L1}) is equal to or larger than the first threshold value in step S31, or when the observation error (Error_{L5}−Error_{L1}) is equal to or larger than the second threshold value in step S32, the positioning unit 32 performs the positioning processing in step S34 without using the signal transmitted from the satellite 2a for which the observation error (Error_{L5}−Error_{L1}) is calculated. That is, the positioning unit 32 zeros the weighting of the signal transmitted from that satellite 2a to perform the positioning processing without using the signal transmitted from that satellite 2a.

In the present embodiment, the processor 30 executes the processing in the calculation step S2 and the positioning step S3 in FIGS. 6 and 7 by executing the positioning program 41. In other words, the positioning program 41 is a program that causes the processor 30, which is a computer, to execute each of the procedures of the calculation step S2 and the positioning step S3 in FIGS. 6 and 7.

The satellite 2a is an example of a “first satellite”, and the satellite 2b is an example of a “second satellite”. The observation pseudo distance PR_{L1} is an example of a “first observation pseudo distance”, and the observation pseudo distance PR_{L5} is an example of a “second observation pseudo distance”.

### 1-4. Functions and Advantages

As described above, according to the positioning instrument 1 of the first embodiment, since the reinforcement information of the CLAS is used together with the difference (PR_{L5}−PR_{L1}) between the observation pseudo distance PR_{L1} based on the L1 signal and the observation pseudo distance PR_{L5} based on the L5 signal in the calculation of the observation error (Error_{L5}−Error_{L1}), the observation error (Error_{L5}−Error_{L1}) can be calculated with high accuracy. In particular, according to the positioning instrument 1 of the first embodiment, since the delay of the L1 signal and the L5 signal due to the influence of the ionospheric layer can be accurately estimated by calculating Iono_{L1} using the reinforcement information of the CLAS, the observation error (Error_{L5}−Error_{L1}) can be calculated with high accuracy. Further, according to the positioning instrument 1 of the first embodiment, since the weighting of the signal transmitted from each of the satellites 2a in the positioning processing is performed in accordance with the observation error (Error_{L5}−Error_{L1}) calculated with high accuracy, the influence of the satellite 2a having a large observation error (Error_{L5}−Error_{L1}) on the result of the positioning processing is reduced, and the positioning accuracy can be improved.

Further, according to the positioning instrument 1 of the first embodiment, since the positioning processing is performed without using the signal transmitted from the satellite 2a in which the observation error (Error_{L5}−Error_{L1}) is equal to or larger than the first threshold value, for example, even when the L1 signal or the L5 signal is spoofed, the possibility that the positioning accuracy is lowered is reduced. In particular, by setting the first threshold value to a value based on the sum of 293 m corresponding to one chip of the L1 signal and 29.3 m corresponding to one chip of the L5 signal, it is possible to appropriately set the first threshold value for determining whether the L1 signal or the L5 signal is spoofed.

In addition, according to the positioning instrument 1 of the first embodiment, since the positioning processing is performed without using the signal transmitted from the satellite 2a in which the observation error (Error_{L5}−Error_{L1}) is equal to or larger than the second threshold value, for example, even when the L1 signal or the L5 signal is affected by the multipath, the possibility that the positioning accuracy decreases is reduced.

### 2. Second Embodiment

Hereinafter, in a second embodiment, the same elements as those in the first embodiment will be denoted by the same reference signs, repetitive description as that in the first embodiment will be omitted or simplified, and contents different from those in the first embodiment will be mainly described.

Since a configuration of the positioning instrument 1 of the second embodiment is substantially the same as that in FIG. 2, the illustration and description thereof will be omitted. However, in the positioning instrument 1 of the second embodiment, the processing of the positioning unit 32 is different from that in the first embodiment. In the second embodiment, the positioning unit 32 performs the positioning processing using a Kalman filter.

The positioning unit 32 executes a prediction part and a correction part of the Kalman filter to estimate a state vector. Elements of the state vector are determined in accordance with an application, and are, for example, a position and a speed in an ECEF coordinate, a bias, and a drift. ECEF is an abbreviation for Earth Centered Earth Fixed.

First, the positioning unit 32 predicts the state vector by a formula (4) in the prediction part. In the formula (4), Xₜ corresponds to the predicted state vector at the current time t, and Xₜ₋₁ corresponds to the state vector at the previous time t−1. F is a state transition model, and for example, a static model, a constant velocity model, and a constant acceleration motion model can be applied. The predicted state vector Xₜ at the current time t is obtained by calculating the state transition model F on the state vector Xₜ₋₁ at the previous time t−1 with the formula (4).

Xₜ=FXₜ₋₁ (4)

In addition, the positioning unit 32 predicts a covariance matrix P of the state vector X with a formula (5) in the prediction part. In the formula (5), Pₜ₋₁ corresponds to the covariance matrix at the previous time t−1, F^{T} is a transposed matrix of the state transition model F, and Q is covariance of the process noise.

P=FPₜ₋₁F^{T}+Q (5)

Then, the positioning unit 32 obtains a residual y before positioning with a formula (6) in the correction part. In the formula (6), z is an observation value, and is, for example, an observation value of a pseudo distance between the positioning instrument 1 and each of the satellites 2a. Further, H is an observation matrix, and Xₜ is a state vector obtained by the formula (4). In the formula (6), a second term obtained by multiplying the state vector Xₜ by the observation matrix H is a distance estimated at a time t.

y=z−HXₜ (6)

In the correction part, the positioning unit 32 obtains the covariance matrix S of the residual y of the observation value with a formula (7). In the formula (7), H is an observation matrix, H^{T} is a transposed matrix of the observation matrix H, and P is a covariance matrix obtained by the formula (5). Further, R is a covariance matrix of observation noise.

S=HPH^{T}+R (7)

Further, the positioning unit 32 obtains a Kalman gain K with a formula (8) in the correction part. In the formula (8), P is the covariance matrix obtained by the formula (5), H^{T} is the transposed matrix of the observation matrix H, and S is the covariance matrix obtained by the formula (7).

$$K = \frac{{PH}^{T}}{S} \qquad ( 8 )$$

Finally, the positioning unit 32 updates the state vector X with a formula (9) in the correction part. In the formula (9), Xₜ is the state vector at the time t obtained by the formula (4), and K is the Kalman gain obtained by the formula (8). In addition, y is a residual before positioning obtained by the formula (6).

X=Xₜ+Ky (9)

From the formula (9), the Kalman gain K is a value that determines how much the residual y before positioning is applied to the state vector X. Further, from the formulas (7) and (8), the Kalman gain K correlates with the covariance matrix R of the observation noise. Then, as each of the elements of the covariance matrix R, the observation error (Error_{L5}−Error_{L1}) with respect to each of the satellites 2a which is a calculation result of the calculation unit 31 is used. Therefore, the observation error (Error_{L5}−Error_{L1}) with respect to each of the satellites 2a is reflected as weighting information in the state vector X obtained by the formula (9). As described above, in the second embodiment, the positioning unit 32 weights the signal transmitted from each of the satellites 2a in accordance with the observation error (Error_{L5}−Error_{L1}), and performs the positioning processing using the Kalman filter.

The other components and functions of the positioning instrument 1 of the second embodiment are substantially the same as those of the positioning instrument 1 of the first embodiment, and therefore, the description thereof will be omitted.

A flowchart showing an example of a procedure of a positioning method performed by the positioning instrument 1 of the second embodiment is substantially the same as that in FIG. 6, and therefore the illustration and description thereof will be omitted. In addition, in the second embodiment, the reception step S1 is substantially the same as steps S11 and S12 of the flowchart illustrated in FIG. 7, and the calculation step S2 is substantially the same as steps S21, S22, S23, and S24 of the flowchart illustrated in FIG. 7, and thus illustration and description thereof will be omitted.

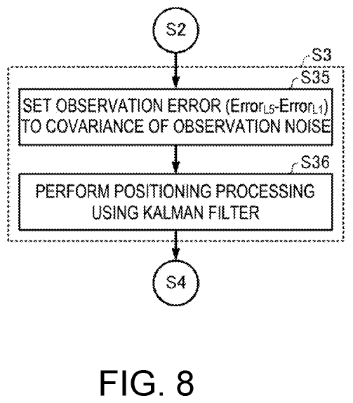

FIG. 8 is a flowchart illustrating an example of a procedure of the positioning step S3 in the second embodiment. As shown in FIG. 8, the positioning step S3 in the second embodiment includes steps S35 and S36. First, in step S35, the positioning unit 32 sets the observation error (Error_{L5}−Error_{L1}) obtained in the calculation step S2 in the covariance matrix R of the observation noise. Then, in step S36, the positioning processing is performed by the formulas (4) to (9) described above using the Kalman filter.

In the second embodiment, the processor 30 executes the positioning program 41 to thereby execute the processing of the calculation step S2 in FIGS. 6 and 7 and the positioning step S3 in FIGS. 6 and 8. In other words, the positioning program 41 is a program that causes the processor 30, which is a computer, to execute each of the procedures of the calculation step S2 in FIGS. 6 and 7 and the positioning step S3 in FIGS. 6 and 8.

When the observation error (Error_{L5}−Error_{L1}) is smaller than the first threshold value in step S31 of FIG. 7, the positioning unit 32 may perform the processing in steps S35 and S36 of FIG. 8 using that observation error (Error_{L5}−Error_{L1}), and when the observation error (Error_{L5}−Error_{L}) is equal to or larger than the first threshold value in step S31, the positioning unit 32 may perform the processing in steps S35 and S36 of FIG. 8 without using that observation error (Error_{L5}−Error_{L1}).

According to the positioning instrument 1 of the second embodiment described above, since the covariance matrix R is weighted in accordance with the observation error (Error_{L5}−Error_{L1}) calculated with high accuracy in the positioning processing using the Kalman filter, it is possible to improve the positioning accuracy.

In addition, according to the positioning instrument 1 of the second embodiment, substantially the same advantages as those of the positioning instrument 1 of the first embodiment can be obtained.

### 3. Third Embodiment

Hereinafter, in a third embodiment, the same component elements as those in the first embodiment or the second embodiment have the same signs, the overlapping description with that in the first embodiment or the second embodiment will be omitted or simplified, and the differences from the first embodiment or the second embodiment will be mainly described.

Since a configuration of the positioning instrument 1 of the third embodiment is substantially the same as that in FIG. 2, the illustration and description thereof will be omitted. However, in the positioning instrument 1 of the third embodiment, the processing of the calculation unit 31 is different from that of the first embodiment and the second embodiment. In the third embodiment, the calculation unit 31 determines the reception environment of the signal transmitted from each of the satellites 2a, and when the calculation unit 31 determines that the reception environment is good, the calculation unit 31 calculates the IFB based on the difference (PR_{L5}−PR_{L1}) between the observation pseudo distance PR_{L1} and the observation pseudo distance PR_{L5}. For example, the calculation unit 31 may determine that the reception environment is good when the reception intensity of the signal from each of the satellites 2a is equal to or larger than a predetermined value. In an environment which does not include the multipath error, such as an open sky environment, the reception environment is good, and in such an environment, the observation error (Error_{L5}−Error_{L1}) with respect to each of the satellites 2a can be regarded as zero. Therefore, a formula (10) is obtained from the formula (3) described above. The calculation unit 31 can calculate the IFB with the formula (10). Since there is a possibility that the calculation result of the IFB varies between the satellites 2a, the calculation unit 31 may calculate the IFB with respect to the plurality of satellites 2a with the formula (10), and then calculate an average value of these IFBs to obtain the IFB.

IFB=(PR_{L5}−PR_{L1})−(−c·(ISC_{L5}−ISC_{L1}))+γ₁₅·Iono_{L1}−Iono_{L1} (10)

The calculation unit 31 may calculate the observation error (Error_{L5}−Error_{L1}) by the formula (3) using the IFB as the calculation result. The calculation unit 31 may obtain, for each of the satellites 2a, a pseudo distance obtained by subtracting the IFB as the calculation result by the calculation unit 31, that is, a pseudo distance having a smaller difference from a geometric distance ρ, and the positioning unit 32 may perform the positioning processing using that pseudo distance.

Since other components and functions of the positioning instrument 1 of the third embodiment are substantially the same as those of the positioning instrument 1 of the first embodiment or the second embodiment, the description thereof will be omitted.

A flowchart showing an example of a procedure of a positioning method performed by the positioning instrument 1 of the third embodiment is substantially the same as that in FIG. 6, and therefore the illustration and description thereof will be omitted. In addition, in the third embodiment, the reception step S1 is substantially the same as steps S11 and S12 of the flowchart illustrated in FIG. 7, and the positioning step S3 is substantially the same as steps S31, S32, S33, and S34 of the flowchart illustrated in FIG. 7 or steps S35 and S36 of the flowchart illustrated in FIG. 8, and thus illustration and description thereof will be omitted.

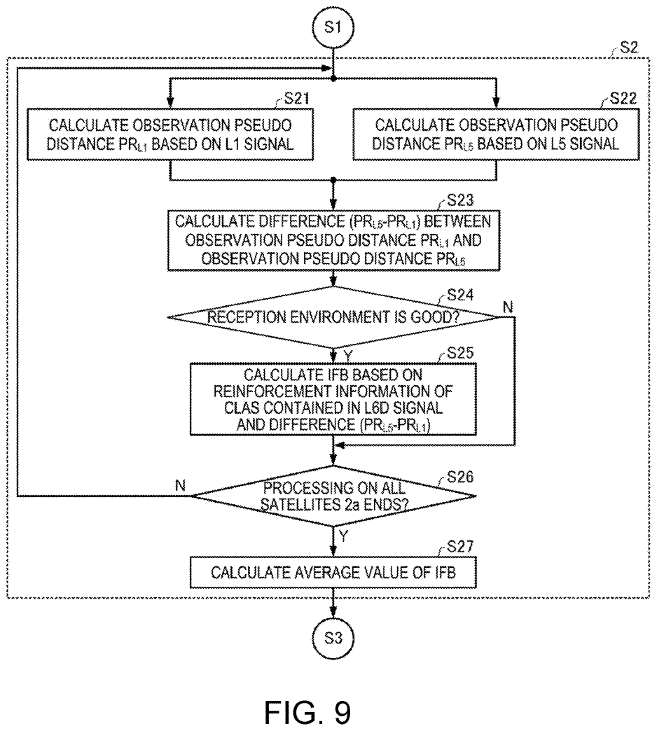

FIG. 9 is a flowchart illustrating an example of a procedure of the calculation step S2 in the third embodiment. As shown in FIG. 9, the calculation step S2 in the third embodiment includes steps S21 to S27. First, in step S21, the calculation unit 31 calculates the observation pseudo distance PR_{L1} to the satellite 2a based on the L1 signal received in the reception step S1 by the receiver 10 from the satellite 2a. In step S22, the calculation unit 31 calculates the observation pseudo distance PR_{L5} to the satellite 2a based on the L5 signal received in the reception step S1 by the receiver 10.

Then, in step S23, the calculation unit 31 calculates the difference (PR_{L5}−PR_{L1}) between the observation pseudo distance PR_{L1} obtained in step S21 and the observation pseudo distance PR_{L5} obtained in step S22.

Then, in step S24, the calculation unit 31 determines whether the reception environment is good. When it is determined in step S24 that the reception environment is good, the calculation unit 31 calculates the IFB in step S25 with the formula (10) described above based on the reinforcement information of the CLAS contained in the L6D signal received in the reception step S1 by the receiver 10 from the satellite 2b and the difference (PR_{L5}−PR_{L1}) obtained in step S23. When it is determined in step S24 that the reception environment is not good, the calculation unit 31 does not perform the processing in step S25.

Then, the calculation unit 31 performs the processing in steps S21 to S25 on all the satellites 2a from which the receiver 10 has received the L1 signal and the L5 signal in the reception step S1.

When the processing in steps S21 to S25 for all the satellites 2a is completed in step S26, the calculation unit 31 finally calculates, in step S27, an average value of all the IFBs obtained in step S25.

In the third embodiment, the processor 30 executes the positioning program 41 to thereby execute the processing in the calculation step S2 in FIGS. 6 and 9 and the positioning step S3 in FIG. 6 and FIG. 7 or 8. In other words, the positioning program 41 is a program that causes the processor 30, which is a computer, to execute each of the procedures of the calculation step S2 in FIGS. 6 and 9 and the positioning step S3 in FIG. 6 and FIG. 7 or 8.

According to the positioning instrument 1 of the third embodiment described above, since the observation error (Error_{L5}−Error_{L1}) is small when the reception environment is good, the IFB can be calculated with high accuracy based on the difference (PR_{L5}−PR_{L1}) between the observation pseudo distance PR_{L1} based on the L1 signal and the observation pseudo distance PR_{L5} based on the L5 signal. Therefore, according to the positioning instrument 1 of the third embodiment, for example, even when the IFB is unknown or the IFB changes due to aging, the observation error (Error_{L5}−Error_{L1}) can be calculated with high accuracy. Further, according to the positioning instrument 1 of the third embodiment, for example, the positioning processing can be performed with high accuracy using the observation pseudo distance having a smaller difference from the geometric distance by subtracting the IFB.

In addition, according to the positioning instrument 1 of the third embodiment, substantially the same advantages as those of the positioning instrument 1 of the first embodiment or the second embodiment can be obtained.

The present disclosure is not limited to the present embodiments, and various modified implementations can be made within the scope of the gist of the present disclosure.

The embodiments and the modifications described above are illustrative only, and the disclosure is not limited thereto. For example, the embodiments and the modifications can be combined as appropriate.

The disclosure includes substantially the same configurations as the configurations described in the embodiments, such as configurations having the same functions, methods, and results, or configurations having the same objects and effects. Further, the present disclosure includes configurations obtained by replacing non-essential portions of the configurations described in the embodiment. Furthermore, the present disclosure includes configurations that exert the same functions and advantages or configurations that can achieve the same objects as those of the configurations described in the embodiment. Further, the present disclosure includes configurations obtained by adding a known technique to the configurations described in the embodiment.

The following contents are derived from the embodiments and modifications described above.

An aspect of a positioning instrument includes:
a receiver configured to receive a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receive a signal in an L6 band transmitted from a second satellite belonging to the quasi-zenith satellite system;
a calculation unit configured to calculate a first observation pseudo distance as an observation value of a pseudo distance to the first satellite based on the first frequency band signal, and calculate a second observation pseudo distance as an observation value of a pseudo distance to the first satellite based on the second frequency band signal; and
a positioning unit configured to perform positioning processing, wherein
the calculation unit calculates an observation error that is a difference between an error contained in the first observation pseudo distance and an error contained in the second observation pseudo distance based on reinforcement information of a centimeter-class positioning reinforcement service (CLAS) contained in the signal in the L6 band and a difference between the first observation pseudo distance and the second observation pseudo distance, and
the positioning unit weights a signal transmitted from the first satellite in the positioning processing in accordance with the observation error.

According to this positioning instrument, since the reinforcement information of the CLAS is used for the calculation of the observation error together with the difference between the first observation pseudo distance based on the first frequency band signal and the second observation pseudo distance based on the second frequency band signal, the observation error can be calculated with high accuracy. Further, according to this positioning instrument, since the weighting of the signal transmitted from the first satellite in the positioning processing is performed in accordance with the observation error calculated with high accuracy, the influence of the first satellite having a large observation error on the result of the positioning processing is reduced, and the positioning accuracy can be improved.

In the aspect of the positioning instrument,
the positioning unit may perform the positioning processing without using a signal transmitted from the first satellite when the observation error is equal to or larger than a first threshold value.

According to this positioning instrument, since the positioning processing is performed without using the signal transmitted from the first satellite having a large observation error, for example, even when the first frequency band signal or the second frequency band signal is spoofed, the possibility that the positioning accuracy is lowered is reduced.

In the aspect of the positioning instrument,
the first threshold value may be a value based on a sum of a distance corresponding to one chip of the first frequency band signal and a distance corresponding to one chip of the second frequency band signal.

According to this positioning instrument, for example, it is possible to appropriately set the first threshold value for determining whether the first frequency band signal or the second frequency band signal is spoofed.

In the aspect of the positioning instrument,
the positioning unit may perform the positioning processing without using a signal transmitted from the first satellite when the observation error is equal to or larger than a second threshold value, and
the second threshold value may be smaller than the first threshold value.

According to this positioning instrument, since the positioning processing is performed without using the signal transmitted from the first satellite having a relatively large observation error, for example, even when the first frequency band signal or the second frequency band signal is affected by the multipath, the possibility that the positioning accuracy decreases is reduced.

In the aspect of the positioning instrument,
the calculation unit may calculate a difference between a distance corresponding to a delay of the first frequency band signal due to an influence of an ionospheric layer and a distance corresponding to a delay of the second frequency band signal due to an influence of the ionospheric layer based on the reinforcement information, and calculate the observation error based on the difference.

According to this positioning instrument, since the delay of the first frequency band signal and the second frequency band signal due to the influence of the ionospheric layer can be accurately estimated using the reinforcement information of the CLAS, the observation error can be calculated with high accuracy.

In the aspect of the positioning instrument, the positioning unit may weight a signal transmitted from the first satellite in accordance with the observation error to perform the positioning processing using a Kalman filter.

According to this positioning instrument, in the positioning processing using the Kalman filter, since the weighting is performed in accordance with the observation error calculated with high accuracy, it is possible to improve the positioning accuracy.

In the aspect of the positioning instrument,
the calculation unit may determine a reception environment of a signal transmitted from the first satellite, and then calculate an IFB as a distance corresponding to a time difference between processing of the first frequency band signal and processing of the second frequency band signal in the positioning instrument based on a difference between the first observation pseudo distance and the second observation pseudo distance when the reception environment is determined to be good.

According to this positioning instrument, since the observation error is small when the reception environment is good, the IFB can be calculated with high accuracy based on the difference between the first observation pseudo distance and the second observation pseudo distance. Therefore, according to this positioning instrument, for example, even when the IFB is unknown or the IFB changes due to aging, the observation error can be calculated with high accuracy. Further, according to this positioning instrument, for example, the positioning processing can be performed with high accuracy using the observation pseudo distance having a smaller difference from the geometric distance by subtracting the IFB.

An aspect of a positioning method includes:
a reception step of receiving a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receiving a signal in an L6 band transmitted from a second satellite belonging to the quasi-zenith satellite system;
a calculation step of calculating a first observation pseudo distance as an observation value of a pseudo distance to the first satellite based on the first frequency band signal, and calculating a second observation pseudo distance as an observation value of a pseudo distance to the first satellite based on the second frequency band signal; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in the signal in the L6 band and a difference between the first observation pseudo distance and the second observation pseudo distance, and
in the positioning step, weighting of a signal transmitted from the first satellite in the positioning processing is performed in accordance with the observation error.

According to this positioning method, since the reinforcement information of the CLAS is used for the calculation of the observation error together with the difference between the first observation pseudo distance based on the first frequency band signal and the second observation pseudo distance based on the second frequency band signal, the observation error can be calculated with high accuracy. Further, according to this positioning method, since the weighting of the signal transmitted from the first satellite in the positioning processing is performed in accordance with the observation error calculated with high accuracy, the influence of the first satellite having a large observation error on the result of the positioning processing is reduced, and the positioning accuracy can be improved.

An aspect of a non-transitory computer-readable storage medium storing a positioning program causes a computer to execute processing including:
a calculation step of calculating a first observation pseudo distance as an observation value of a pseudo distance to a first satellite belonging to a quasi-zenith satellite system or a positioning satellite system different from the quasi-zenith satellite system based on a first frequency band signal as a signal in a first frequency band transmitted from the first satellite, and calculating a second observation pseudo distance as an observation value of a pseudo distance to the first satellite based on a second frequency band signal as a signal in a second frequency band which is transmitted from the first satellite; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in a signal in an L6 band transmitted from a second satellite belonging to the quasi-zenith satellite system and a difference between the first observation pseudo distance and the second observation pseudo distance, and
in the positioning step, weighting of a signal transmitted from the second satellite in the positioning processing is performed in accordance with the observation error.

According to this positioning program, since the computer uses the reinforcement information of the CLAS for the calculation of the observation error together with the difference between the first observation pseudo distance based on the first frequency band signal and the second observation pseudo distance based on the second frequency band signal, the observation error can be calculated with high accuracy. Further, according to this positioning program, since the computer performs the weighting of the signal transmitted from the first satellite in the positioning processing in accordance with the observation error calculated with high accuracy, the influence of the first satellite having a large observation error on the result of the positioning processing is reduced, and the positioning accuracy can be improved.

What is claimed is:

1. A positioning instrument comprising:
a receiver configured to receive a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receive a signal in an L6 band transmitted from a second satellite belonging to the quasi-zenith satellite system;
a calculation unit configured to calculate a first observation pseudo distance as an observation value of a pseudo distance to the first satellite based on the first frequency band signal, and calculate a second observation pseudo distance as an observation value of a pseudo distance to the first satellite based on the second frequency band signal; and
a positioning unit configured to perform positioning processing, wherein
the calculation unit calculates an observation error that is a difference between an error contained in the first observation pseudo distance and an error contained in the second observation pseudo distance based on reinforcement information of a centimeter-class positioning reinforcement service (CLAS) contained in the signal in the L6 band and a difference between the first observation pseudo distance and the second observation pseudo distance, and
the positioning unit weights a signal transmitted from the first satellite in the positioning processing in accordance with the observation error.

2. The positioning instrument according to claim 1, wherein
the positioning unit performs the positioning processing without using a signal transmitted from the first satellite when the observation error is equal to or larger than a first threshold value.

3. The positioning instrument according to claim 2, wherein
the first threshold value is a value based on a sum of a distance corresponding to one chip of the first frequency band signal and a distance corresponding to one chip of the second frequency band signal.

4. The positioning instrument according to claim 3, wherein
the positioning unit performs the positioning processing without using a signal transmitted from the first satellite when the observation error is equal to or larger than a second threshold value, and
the second threshold value is smaller than the first threshold value.

5. The positioning instrument according to claim 4, wherein
the calculation unit calculates a difference between a distance corresponding to a delay of the first frequency band signal due to an influence of an ionospheric layer and a distance corresponding to a delay of the second frequency band signal due to an influence of the ionospheric layer based on the reinforcement information, and calculates the observation error based on the difference.

6. The positioning instrument according to claim 1, wherein
the positioning unit weights a signal transmitted from the first satellite in accordance with the observation error to perform the positioning processing using a Kalman filter.

7. The positioning instrument according to claim 1, wherein
the calculation unit determines a reception environment of a signal transmitted from the first satellite, and then calculates an IFB as a distance corresponding to a time difference between processing of the first frequency band signal and processing of the second frequency band signal in the positioning instrument based on a difference between the first observation pseudo distance and the second observation pseudo distance when the reception environment is determined to be good.

8. A positioning method comprising:
a reception step of receiving a first frequency band signal as a signal in a first frequency band and a second frequency band signal as a signal in a second frequency band which are transmitted from a first satellite belonging to a quasi-zenith satellite system or a positioning satellite system different from the quasi-zenith satellite system, and receiving a signal in an L6 band transmitted from a second satellite belonging to the quasi-zenith satellite system;
a calculation step of calculating a first observation pseudo distance as an observation value of a pseudo distance to the first satellite based on the first frequency band signal, and calculating a second observation pseudo distance as an observation value of a pseudo distance to the first satellite based on the second frequency band signal; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in the signal in the L6 band and a difference between the first observation pseudo distance and the second observation pseudo distance, and
in the positioning step, weighting of a signal transmitted from the first satellite in the positioning processing is performed in accordance with the observation error.

9. A non-transitory computer-readable storage medium storing a positioning program causes a computer to execute processing comprising:
a calculation step of calculating a first observation pseudo distance as an observation value of a pseudo distance to a first satellite belonging to a quasi-zenith satellite system or a positioning satellite system different from the quasi-zenith satellite system based on a first frequency band signal as a signal in a first frequency band transmitted from the first satellite, and calculating a second observation pseudo distance as an observation value of a pseudo distance to the first satellite based on a second frequency band signal as a signal in a second frequency band which is transmitted from the first satellite; and
a positioning step of performing positioning processing, wherein
in the calculation step, an observation error that is a difference between an error contained in the first observation pseudo distance and an error contained in the second observation pseudo distance is calculated based on reinforcement information of a centimeter-class positioning reinforcement service (CLAS) contained in a signal in an L6 band transmitted from a second satellite belonging to the quasi-zenith satellite system and a difference between the first observation pseudo distance and the second observation pseudo distance, and
in the positioning step, weighting of a signal transmitted from the second satellite in the positioning processing is performed in accordance with the observation error.
